(19) United States
(12) Patent Application Publication
(10) Pub. No.: US 2005/0241543 A1
(43) Pub. Date: Nov. 3, 2005

(54) Cement-based systems using plastification/extrusion auxiliaries prepared from raw cotton linters

(76) Inventors: Wolfgang Hagen, Meerbusch (DE); Wilfried Hohn, Erftstadt (DE); Wolfgang Hildebrandt, Dinslaken (DE); Dieter Schweizer, Duesseldorf (DE)

Correspondence Address: Hercules Incorporated;Hercules Plaza, 1313 N. Market Street, Wilmington, DE, 19894-0001, US

(21) Appl. No.: 11/114,720

(22) Filed: Apr. 25, 2005

Related U.S. Application Data
(60) Provisional application No. 60/565,643, filed on Apr. 27, 2004.

(51) Int. Cl. C04B 14/00

(52) U.S. Cl. 106/805

(57) ABSTRACT

A mixture composition of a cellulose ether made from raw cotton linters and at least one additive is used in a cement extrusion mortar composition wherein the amount of the cellulose ether in the cement extrusion mortar composition is significantly reduced. When this cement extrusion mortar composition is mixed with a sufficient amount of water and extruded to form an object with comparable or lower crack formation, the plastification and/or extrusion properties of the resulting wet mortar are improved or comparable as compared to when using conventional similar cellulose ethers.

This application claims the benefit of U.S. Provisional Application No. 60/565,643, filed Apr. 27, 2004

### FIELD OF THE INVENTION

This invention relates to a mixture composition for cement extrusion process using an improved water-retaining agent and/or plastification/extrusion auxiliary that is prepared from raw cotton linters.

### BACKGROUND OF THE INVENTION

Traditional cement-based mortars are often simple mixtures of cement and sand. The dry mixture is mixed with water to form a mortar. These traditional mortars, per se, have poor fluidity or trowellability and workability. Consequen5ly, the application of these mortars is labor intensive, especially in summer months under hot weather conditions, because of the rapid evaporation or removal of water from the mortar, which results in inferior or poor workability as well as short open and correction times and insufficient hydration of cement

The physical characteristics of a hardened traditional mortar are strongly influenced by its hydration process, and thus, by the rate of water removal therefrom during the setting operation. Any influence, which affects these parameters by increasing the rate of water removal or by diminishing the water concentration in the mortar at the onset of the setting reaction, can cause a deterioration of the physical properties and crack formation within the resulting mortar.

To overcome, or to minimize, the above mentioned water-loss problems, the prior art discloses uses of cellulose ethers as water retention agents to mitigate this problem. An example of this prior art is U.S. Pat. No. 4,501,617 that discloses the use of hydroxypropylhydroxyethylcellulose (HPHEC) as a water retention aid for improving trowellability or fluidity of mortar. The uses of cellulose ether in dry-mortar applications are disclosed in prior art patents, such as DE 3046585, EP 54175, DE 3909070, DE3913518, CA2456793, and EP 773198.

German publication 4,034,709 A1 discloses the use of raw cotton linters to prepare cellulose ethers as additives to cement based hydraulic mortars or concrete compositions.

Cellulose ethers (CEs) represent an important class of commercially important water-soluble polymers. These CEs are capable of increasing viscosity of aqueous media. This viscosifying ability of a CE is primarily controlled by its molecular weight, chemical substituents attached to it, and conformational characteristics of the polymer chain. CEs are used in many applications, such as construction, paints, food, personal care, pharmaceuticals, adhesives, detergents/cleaning products, oilfield, paper industry, ceramics, polymerization processes, leather industry, and textiles.

Methylcellulose (MC), methylhydroxyethylcellulose (MHEC), ethylhydroxyethylcellulose (EHEC), methylhyd roxypropylcellulose (MHPC), hydroxyethylcellulose (HEC), and hydrophobically modified hydroxyethylcellulose (HMHEC) either alone or in combination are most widely used for dry mortar formulations in the construction industry. By a dry mortar formulation is meant a blend of gypsum, cement, and/or lime as the inorganic binder used either alone or in combination with aggregates (e.g., silica and/or carbonate sand/powder), and additives.

For their use, these dry mixtures are mixed with water and used as wet materials. For the intended applications, water-soluble polymers that give high viscosity upon dissolution in water are required. By using MC, MHEC, MHPC, EHEC, HEC, or HMHEC or combinations thereof, desired dry mortar properties such as high water retention (and consequently a defined control of water content and less crack formation) are achieved. Additionally, an improved workability and satisfactory consistency of the resulting material can be observed. Since an increase in CE solution viscosity results in improved water retention capability and adhesion properties, high molecular weight CEs are desirable in order to work more efficiently and cost effectively. In order to achieve high solution viscosity, the starting cellulose ether has to be selected carefully. Currently, by using purified cotton linters or high viscosity wood pulps, the highest 2 wt % solution viscosity that can be achieved is about 70,000-80,000 mPas (using Brookfield RVT viscometer at 20° C. and 20 rpm, using spindle number 7).

Cellulose ethers (CEs) are used as extrusion auxiliaries in cement extrusion application. In this application a cement-based dry-mixture is mixed with water. In the subsequent extrusion step the plastified material is extruded through an extrusion die. In order to achieve plasticity of the cement-based materials a plastification agent is needed, which provides good plasticity to the cement-based mixture as well as stable and good extrusion and sufficient green strength. Here, for cost reasons, it is desirable to have similar or even better plasticity at a lower addition level. Because of their good binding properties, high viscosity cellulose ethers are needed to have good plastification properties. In addition, because of their high water retention capability these high viscosity CEs prevent a too fast loss of water within the cement-based mortar, which results in less crack formation.

Because of their water retention, adhesion, and binding properties, cellulose ethers such as methylcellulose, methylhydroxyethylcellulose, methylhydroxypropylcellulose, hydroxyethylcellulose or hydrophobically modified hydroxyethylcellulose (HMHEC) or combinations thereof, are typically used as auxiliaries in these cement extrusion processes. Examples of this prior art are US2003071392, JP9142962, JP8225355, JP8183647, and JP4164604.

A need still exist in the cement-extrusion process for having a water retention agent that can be used in a cost effective manner to improve the plastification and extrusion performance properties as well as to reduce the tendency for crack formation of the resulting extruded material. In order to assist in achieving this result, it would be preferred to provide a water retention agent that provides a Brookfield solution viscosity of preferably greater than about 80,000 mPas and still be cost effective for use as a thickener and/or water retention agent.

### SUMMARY OF THE INVENTION

The present invention relates to a mixture composition for use in cement extrusion mortar composition of a cellulose either in an amount of 20 to 99.9 wt % of alkylhydroxyalkylcelluloses and hydroxyalkylcelluloses, and mixtures thereof, prepared from raw cotton linters, and at least one additive in an amount of 0.1 to 80 wt % of organic or inorganic thickening agents, anti-sag agents, air entraining agents, wetting agents, defoamers, superplasticizers, superabsorber, dispersants, calcium-complexing agents, retarders, accelerators, water repellants, redispersible powders, biopolymers, and fibres; When the mixture composition, is used in a dry cement extrusion mortar composition and mixed with a sufficient amount of water, cement extrusion mortar composition produces a cement extrusion mortar that can be used as mortar for extrusion of pipes, bricks, plates, distance holders or other objects wherein the amount of the mixture composition in the mortar composition is significantly reduced with comparable or lower crack formation while plastification and/or extrusion properties of the resulting wet mortar are improved or comparable as compared to when using conventional similar cellulose ethers.

The present invention, also, is directed to a dry cement based extrusion mortar composition of a hydraulic cement, fine aggregate material, and a water-retaining agent and/or plastification or extrusion auxiliary of at least one cellulose ether prepared from raw cotton linters.

When the dry cement based extrusion mortar composition is mixed with a sufficient amount of water, it produces a mortar that can be used as mortar for extrusion of pipes, bricks, plates, distance holders or other objects wherein the amount of the cellulose ether in the mortar is significantly reduced with comparable or lower crack formation while plastification and/or extrusion properties are improved or comparable as compared to when using conventional similar cellulose ethers.

### DETAILED DESCRIPTION OF THE INVENTION

It has been found that certain cellulose ethers, particularly, alkylhydroxyalkylcelluloses and hydroxyalkylcelluloses, made from raw cotton linters (RCL) have unusually high solution viscosity relative to the viscosity of conventional, commercial cellulose ethers made from purified cotton linters or high viscosity wood pulps. The use of these cellulose ethers in cement extrusion mortar compositions provides several advantages (i.e., lower cost in use and better application properties) and improved performance properties that were hitherto not possible to achieve using conventional cellulose ethers.

Cement extrusion is used, e.g., in order to produce cement-based bricks, pipes, distance holders or panels. In the extrusion process a plastified cement-based mass is extruded through a die of an extruder in order to give a certain shape to the mass.

In accordance with this invention, cellulose ethers of alkylhydroxyalkylcelluloses and hydroxyalkylcelluloses are prepared from cut or uncut raw cotton linters. The alkyl group of the alkylhydroxyalkylcelluloses has 1 to 24 carbon atoms and the hydroxyalkyl group has 2 to 4 carbon atoms. Also, the hydroxyalkyl group of the hydroxyalkylcelluloses has 2 to 4 carbon atoms. These cellulose ethers provide unexpected and surprising benefits to the cement extrusion mortar. Because of the extremely high viscosity of the RCL-based CEs, efficient application performance in cement extrusion mortar could be observed. RCL based CEs provided good plasticity to the cement-based material. Even at lower use level of the RCL based CEs as compared to currently used high viscosity commercial CEs, similar or improved application performance with respect to crack formation (less cracks), plastification and/or extrusion properties are achieved.

In accordance with the present invention, the mixture composition has an amount of the cellulose ether of 20 to 99.9 wt %, preferably 70 to 99.5 wt %.

The RCL based water-soluble, nonionic CEs of the present invention include (as primary CEs), particularly, alkylhydroxyalkylcelluloses and hydroxyalkylcelluloses made from raw cotton linters (RCL). Examples of such derivatives include methylhydroxyethylcelluloses (MHEC), methylhydroxypropylcelluloses (MHPC), methylethylhydroxyethylcelluloses (MEHEC), ethylhydroxyethylcelluloses (EHEC), hydrophobically modified ethylhydroxyethylcelluloses (HMEHEC), hydroxyethylcelluloses (HEC), and hydrophobically modified hydroxyethylcelluloses (HMHEC), and mixtures thereof. The hydrophobic substitutents can have 1 to 25 carbon atoms depending on their chemical composition, they can have, where applicable, a methyl or ethyl degree of substitution (DS) of 0.5 to 2.5, a hydroxyalkyl molar substitution (HA-MS) of about 0.01 to 6, and a hydrophobic substituent molar substitution (HS-MS) of about 0.01 to 0.5 per anhydroglucose unit. More particularly, the present invention relates to the use of these water-soluble, nonionic CEs as an efficient water-retaining agent and/or plastification or extrusion auxiliary in dry cement extrusion mortar compositions performing auxiliary in cement extrusion process.

In practicing the present invention, conventional CEs made from purified cotton linters and wood pulps (secondary CEs) can be used in combination with RCL based CEs. The preparation of various types of CEs from purified celluloses is known in the art. These secondary CEs can be used in combination with the primary RCL-CEs for practicing the present invention. These secondary CEs will be referred to in this application as conventional CEs because most of them are commercial products or known in the marketplace and/or literature.

Examples of the secondary CEs are methylcellulose (MC), methylhydroxyethylcellulose (MHEC), methylhydroxypropylcellulose (MHPC), hydroxyethylcellulose (HEC), ethylhydroxyethylcellulose (EHEC), methylethylhydroxyethylcellulose (MEHEC), hydrophobically modified ethylhydroxyethylcelluloses (HMEHEC), hydrophobically modified hydroxyethylcelluloses (HMHEC), sulfoethyl methylhydroxyethylcelluloses (SEMHEC), sulfoethyl methylhydroxypropylcelluloses (SEMHPC), and sulfoethyl hydroxyethylcelluloses (SEHEC).

In accordance with the present invention, one preferred embodiment makes use of MHEC and MHPC having an aqueous Brookfield solution viscosity of greater than 80,000 mPas, preferably of greater than 90,000 mpas, as measured on a Brookfield RVT viscometer at 20° C. and 20 rpm, and a concentration of 2 wt % using spindle number 7.

In accordance with the present invention, the mixture composition has an amount of at least one additive of between 0.1 and 80 wt %, preferably between 0.5 and 30 wt %. Examples of the additives are organic or inorganic thickening agents and/or secondary water retention agents, anti-sag agents, air entraining agents, wetting agents, defoamers, superplasticizers, superabsorber, dispersants, calcium-complexing agents, retarders, accelerators, water repellants, redispersible powders, biopolymers, and fibres. An example of the organic thickening agent is polysaccharides. Other examples of additives are calcium chelating agents, fruit acids, and surface active agents.

More specific examples of the additives are homo- or co-polymers of acrylamide. Examples of such polymers are polyacrylamide, poly(acrylamide-co-sodium acrylate), poly(acrylamide-co-acrylic acid), poly(acrylamide-co-sodium-acrylamido methylpropanesulfonate), poly(acrylamide-co-acrylamido methylpropanesulfonic acid), poly(acrylamide-co-diallyidimethylammonium chloride), poly(acrylamide-co-(acryloylamino)propyltrimethylammoniumchloride), poly(acrylamide-co-(acryloyl)ethyltrimethylammoniumchloride), and mixtures thereof.

Examples of the polysaccharide additives are starch ether, starch, guar, guar derivatives, dextran, chitin, chitosan, xylan, xanthan gum, welan gum, gellan gum, mannan, galactan, glucan, arabinoxylan, alginate, and cellulose fibres.

Other specific examples of the additives are gelatin, polyethylene glycol, casein, lignin sulfonates, naphthalene-sulfonate, sulfonated melamine-formaldehyde condensate, sulfonated naphthalene-formaldehyde condensate, polyacrylates, polycarboxylateether, polystyrene sulphonates, phosphates, phosphonates, cross-linked homo- or co-polymers of acrylic acid and salts thereof, calcium-salts of organic acids having 1 to 4 carbon atoms, salts of alkanoates, aluminum sulfate, metallic aluminum, bentonite, montmorillonite, sepiolite, polyamide fibres, polypropylene fibres, polyvinyl alcohol, and homo-, co-, or terpolymers based on vinyl acetate, maleic ester, ethylene, styrene, butadiene, vinyl versatate, and acrylic monomers.

The mixture compositions of this invention can be prepared by a wide variety of techniques known in the prior art. Examples include simple dry blending, spraying of solutions or melts onto dry materials, co-extrusion, or co-grinding.

In accordance with the present invention, the mixture composition when used in a dry cement extrusion mortar and mixed with a sufficient amount of water to produce a mortar, the amount of the mixture, and consequently the cellulose ether, is significantly reduced. The reduction of the mixture or cellulose ether is at least 5%, preferably at least 10%. Even with such reductions in the CE, comparable or lower crack formation is found and the plastification and/or extrusion behavior of the wet mortar is comparable or improved as compared to when using conventional similar cellulose ethers.

The mixture composition of the present invention can be marketed directly or indirectly to cement based mortar manufacturers who can use such mixtures directly into their manufacturing facilities. The mixture composition can also be custom blended to preferred requirements of different manufacturers.

The cement extrusion mortar composition of the present invention has an amount of CE of from about 0.05 to 2.0 wt %. The amount of the at least one additive is from about 0.0001 to 15 wt %. These weight percentages are based on the total dry weight of all of the ingredients of the dry cement based mortar composition.

In accordance with the present invention, the dry cement based mortar compositions have aggregate material present in the amount of 10-90 wt %, preferably in the amount of 20-80 wt %. Examples of the aggregate material are silica sand, dolomite, limestone, lightweight aggregates (e.g., expanded polystyrene, hollow glass spheres, perlite, cork, expanded vermiculites), rubber crumbs (recycled from car tires), and fly ash. By “fine” is meant that the aggregate materials have particle sizes up to 3.0 mm, preferably 1.0 mm.

In accordance with the present invention, the hydraulic cement component is present in the amount of 10-90 wt %, and preferably in the amount of 15-70 wt %. Examples of the hydraulic cement are Portland cement, Portland-slag cement, Portland-silica fume cement, Portland-pozzolana cement, Portland-burnt shale cement, Portland-limestone cement, Portland-composite cement, blasffurnace cement, pozzolana cement, composite cement and calcium aluminate cement.

In accordance with the present invention, the cement-based dry mortar composition has an amount of at least one mineral binder of between 10 and 80 wt %, preferably between 20 and 60 wt %. Examples of the at least one mineral binder are cement, pozzolana, blast furnace slag, hydrated lime, gypsum, and hydraulic lime.

In accordance with a preferred embodiment of the present invention, cellulose ethers are prepared according to U.S. patent application Ser. No. 10/822,926, filed Apr. 13, 2004, which is herein incorporated by reference. The starting material of the present invention is a mass of unpurified raw cotton linter fibers that has a bulk density of at least 8 grams per 100 ml. At least 50 wt % of the fibers in this mass have an average length that passes through a US sieve screen size number 10 (2 mm openings). This mass of unpurified raw cotton linters is prepared by obtaining a loose mass of first cut, second cut, third cut and/or mill run unpurified, natural, raw cotton linters or mixtures thereof containing at least 60% cellulose as measured by AOCS (American Oil Chemists' Society) Official Method Bb 3-47 and commuting the loose mass to a length wherein at least 50 wt % of the fibers pass through a US standard sieve size no. 10. The cellulose ether derivatives are prepared using the above mentioned comminuted mass or raw cotton linter fibers as the starting material. The cut mass of raw cotton linters are first treated with a base in a slurry or high solids process at a cellulose concentration of greater than 9 wt % to form an activated cellulose slurry. Then, the activated cellulose slurry is reacted for a sufficient time and at a sufficient temperature with an etherifying agent to form the cellulose ether derivative, which is then recovered. The modification of the above process to prepare the various CEs of the present invention is well known in the art.

The CEs of this invention can also be prepared from uncut raw cotton linters that are obtained in bales of the RCL that are either first, second, third cut, and/or mill run from the manufacturer.

Raw cotton linters including compositions resulting from mechanical cleaning of raw cotton linters, which are substantially free of non-cellulosic foreign matter, such as field trash, debris, seed hulls, etc., can also be used to prepare cellulose ethers of the present invention. Mechanical cleaning techniques of raw cotton linters, including those involving beating, screening, and air separation techniques, are well known to those skilled in the art. Using a combination of mechanical beating techniques and air separation techniques, fibers are separated from debris by taking advantages of the density difference between fibers and debris. A mixture of mechanically cleaned raw cotton linters and “as is” raw cotton linters can also be used to manufacture cellulose ethers.

When compared with the cement extrusion mortar prepared with conventional cellulose ethers, the mortars of this invention are comparable or improved in plastification and/or extrusion behavior and show lower or comparable crack formation which are important parameters used widely in the art to characterize these cement-based mortars.

“Plastification” is defined as the ability of a mass to change its shape permanently under application of force according to the applied force without breaking or being destroyed.

Crack formation was rated subjectively by the corresponding lab-person via visual judgment of the surface and appearance of the plastified material.

Because of the lower CE-addition level when compared with cement extrusion mortars prepared with conventional cellulose ethers, the mortars of this invention have the advantage that they can be used at a lower addition level resulting lower production costs for the extruded cement-based product.

Typical cement extrusion materials may contain some or all of the following components:

TABLE A
Typical Prior Art Composition of Cement Extrusion Mortars

| | | Typical |
|---|---|---|
| Component | Examples | amount |
| Cement | CEM I (Portland cement), CEM II, CEM | 10-90% |
| | III (blast-furnace cement), CEM IV | |
| | (pozzolana cement), CEM V (composite | |
| | cement), CAC (calcium aluminate cement) | |
| Other mineral | Hydrated lime, gypsum, puzzolana, | 0-10% |
| binders | blast furnace slag, and hydraulic lime | |
| Aggregate/ | Silica sand, dolomite, limestone, | 30-90% |
| lightweight | perlite, expanded polystyrene, cork, | |
| aggregates | expanded vermiculite, and hollow | |
| | glass spheres | |
| Accelerator/ | Calcium formate, sodium carbonate, | 0-2% |
| retarder | lithium carbonate | |
| Fibre | Cellulose fibre, polyamide fibre, | 0-10% |
| | polypropylene fibre | |
| Cellulose-ether | MC, MHEC, MHPC, EHEC, HEC, HMHEC | 0-2% |
| Other additives | Air entraining agents, defoamers, | 0-30% |
| | hydrophobing agents, wetting agents, | |
| | superplasticizers anti-sag agents, Ca- | |
| | complexing agents, spray dried resins | |

The invention is illustrated by the following Examples. Parts and percentages are by weight, unless otherwise noted.

### EXAMPLE 1

Examples 1 and 2 show some of the chemical and physical properties of the polymers of the instant invention as compared to similar commercial polymers.

Determination of Substitution

Cellulose ethers were subjected to a modified Zeisel ether cleavage at 150° C. with hydriodic acid. The resulting volatile reaction products were determined quantitatively with a gas chromatograph.

Determination of Viscosity

The viscosities of aqueous cellulose ether solutions were determined on solutions having concentrations of 1 wt % and 2 wt %. When ascertaining the viscosity of the cellulose ether solution, the corresponding methylhydroxyalkylcellulose was used on a dry basis, i.e., the percentage moisture was compensated by a higher weight-in quantity. Viscosities of currently available, commercial methylhydroxyalkylcelluloses, which are based on purified cotton linters or high viscosity wood pulps have maximum 2 wt % aqueous solution viscosity of about 70,000 to 80,000 mPas (measured using Brookfield RVT at 20° C. and 20 rpm).

In order to determine the viscosities, a Brookfield RVT rotational viscometer was used. All measurements at 2 wt % aqueous solutions were made at 20° C. and 20 rpm using spindle number 7.

Sodium Chloride Content

The sodium chloride content was determined by the Mohr method. 0.5 g of the product was weighed on an analytical balance and was dissolved in 150 ml of distilled water. 1 ml of 15% HNO₃ was then added after 30 minutes of stirring. Afterwards, the solution was titrated with normalized silver nitrate (AgNO₃)-solution using a commercially available apparatus.

Determination of Moisture

Moisture was measured using a commercially available moisture balance at 105° C. The moisture content was the quotient from the weight loss and the starting weight, and is expressed in percent.

Determination of Surface Tension

The surface tensions of the aqueous cellulose ether solutions were measured at 20° C. and a concentration of 0.1 wt % using a Krüss Digital-Tensiometer K10. For determination of surface tension the so-called “Wilhelmy Plate Method” was used, where a thin plate is lowered to the surface of the liquid and the downward force directed to the plate is measured.

TABLE 1
Analytical Data

| | Methoxyl/ | | | | |
|---|---|---|---|---|---|
| | Hydroxy- | | | | |
| | ethoxyl or | | | | |
| | hydroxy- | Viscosity On dry basis | | Mois- | Surface |
| | propoxyl | at 2 wt % | at 1 wt % | ture | tension* |
| Sample | [%] | [mPas] | [mPas] | [%] | [mN/m] |
| RCL-MHPC | 26.6/2.9 | 95400 | 17450 | 2.33 | 35 |
| MHPC 65000 | 27.1/3.9 | 59800 | 7300 | 4.68 | 48 |
| (control) | | | | | |
| RCL-MHEC | 23.3/8.4 | 97000 | 21300 | 2.01 | 43 |
| MHEC 75000 | 22.6/8.2 | 67600 | 9050 | 2.49 | 53 |
| (control) | | | | | |

*0.1 wt % aqueous solution at 20° C.

Table 1 shows the analytical data of a methylhydroxyethylcellulose and a methylhydroxypropylcellulose derived from. RCL. The results clearly indicate that these products have significantly higher visciosities than current, commercially available high viscosity CEs. At a concentration of 2 wt %, viscosities of about 100,000 mPas were found. Because of their extremely high values, it was more reliable and easier to measure viscosities of 1 wt % aqueous solutions. At this concentration, commercially available high viscosity methylhydroxyethylcelluloses and methylhydroxypropylcelluloses showed viscosities in the range of 7300 to about 9000 mPas (see Table 1). The measured values for the products based on raw cotton linters were significantly higher than the commercial materials. Moreover, it is clearly shown in Table 1 that the cellulose ethers which are based on raw cotton linters have lower surface tensions than the control samples.

### EXAMPLE 2

All tests were conducted in a cement extrusion mortar basic-mixture of 65.00 wt % Portland Cement CEM I 42.5R and 35.00 wt % silica sand with particle sizes of 0.1-0.3 mm. In all experiments the amount of basic-mixture used was 350 g.

Plastification Procedure

Prior to the plastification process the CE was dry-blended with a pre-blend of sand and cement (350 g of pre-blend) and put into a plastic beaker. Water was added to the blend while mixing the blend with a spatula to ensure a good wetting. Afterwards, a Brabender plasticorder was started and the wetted material was filled into the mixing chamber of the Brabender-plasticorder (equipped with two kneader blades) within 10 seconds. The material was plastified and/or kneaded for 9 minutes. After this kneading time, the torque of the Brabender as well as the quality of the mass did not change anymore (end torque).

The Brabender-plasticorder was stopped and the mass was taken out.

Methylhydroxyethylcellulose (MHEC) and methylhydroxypropylcellulose (MHPC) made from RCL were tested in a cement extrusion mortar basic-mixture in comparison to commercially available, high viscosity MHEC and MHPC (from Hercules) used as the controls.

For cement extrusion an auxiliary is used in order to provide good plasticity to the cement-based mixture as well as stability, good extrusion, and sufficient green strength. These properties are essential for the extrusion process.

Thereafter, the different cellulose ethers were tested concerning their ability to plastify the cement extrusion mortar basic-mixture using a plasticorder. All samples were plastified and/or kneaded for 9 minutes. Afterwards, the plasticorder was opened and the resulting material was subjectively rated with respect to quality of plastification as well as crack formation. The outcome of this investigation is shown in Table 2.

TABLE 2
Testing of different cellulose ethers in plastification
trials (water factor 0.15⁽¹⁾)

| | Dosage | | | |
|---|---|---|---|---|
| | (on basic- | Plasti- | Appearance | |
| Cellulose | mixture) | fication | of kneaded | |
| ether | [wt %] | curve | material¹⁾ | Cracks |
| MHEC 75000 | 0.2 | Typical | * | strong tendency |
| | | | | for crack |
| | | | | formation |
| RCL MHEC | 0.2 | slightly | **⁺ | low tendency |
| | | higher | | for crack |
| | | maximum | | formation |
| | | torque | | |
| MHPC 65000 | 0.2 | slightly | * | strong tendency |
| | | higher | | for crack |
| | | torque | | formation |
| | | maximum | | |
| RCL MHPC | 0.2 | typical | **⁺ | low tendency |
| | | plasti- | | for crack |
| | | corder | | formation |
| | | curve | | |
| MHEC 75000 | 0.3 | typical | **⁺ | low tendency |
| | | | | for crack |
| | | | | formation |
| MHPC 65000 | 0.3 | typical | **⁺ | low tendency |
| | | | | for crack |
| | | | | formation |

*no plastification;
****very good plastification;
⁺= ½*
⁽¹⁾water factor: amount of used water divided by amount of used dry mortar,
e.g., 15 g of water on 100 g of dry mortar results in a water factor of 0.15

The results clearly show the high efficiency of both RCL-based products in comparison to the control samples. At the same addition level of 0.2% the RCL-CEs show an acceptable plastification behavior as well as low crack formation, whereas the control samples were not able to plastify the cement-based system under these conditions. When addition level of the control sample was increased to 0.3%, similar performance results as compared to the RCL-CEs were found.

Thus, both RCL-based CEs are efficient plastification and/or extrusion auxiliaries for cement extrusion process. They are able to plastify the cement-based material even at a significant lower addition level as compared to the control samples which are currently commercially used high viscosity CEs.

### EXAMPLE 3

All tests were conducted in a cement extrusion mortar basic-mixture of 65.00 wt % Portland Cement CEM I 42.5R and 35.00 wt % silica sand with particle sizes of 0.1-0.3 mm. In all experiments the amount of used basic-mixture was 350 g.

Plastification Procedure

Plastification procedure is described in Example 9.

Methylhydroxyethylcellulose (MHEC) made from RCL was tested either alone or in combination with superplasticizer (modified RCL-MHEC) in a cement extrusion basic-mixture in comparison to control samples of commercially available, high viscosity MHEC.

The different cellulose ethers and modified cellulose ethers, respectively, were tested concerning their ability to plastify the cement-based basic-mixture using a plasticorder. All samples were plastified and/or kneaded for 9 minutes. Afterwards, the plasticorder was opened and the resulting material was subjectively rated with respect to quality of plastification as well as crack formation. The outcome of this investigation is shown in Table 3.

TABLE 3
Testing of different CEs/modified CEs in plastification trials (water factor 0.15)

| | Dosage (on | Plastifcation curve | | Appearance of | Cracks |
|---|---|---|---|---|---|
| | basic- | Maximum | Equilibrium | | |
| | mixture) | torque | torque | | |
| | [wt %] | [Nm] | [Nm] | Kneaded material¹⁾ | |
| 100% MHEC 75000 | 0.2 | 9 | 8 | * | Strong tendency for |
| | | | | | crack formation |
| 100% RCL MHEC | 0.2 | 12 | 9 | **⁺ | Low tendency for |
| | | | | | crack formation |
| 90% MHEC 75000/ | 0.2 | 9 | 7 | *** | Low tendency for |
| 10% Calcium- | | | | | crack formation |
| ligninsulfonate | | | | | |
| 90% RCL MHEC/ | 0.2 | 8 | 9 | **** | No tendency for |
| 10% Calcium- | | | | | crack formation |
| ligninsulfonate | | | | | |

¹⁾*no plastification; ****very good plastification; = ½*

The results again confirmed the tendencies, which were found in Example 9: RCL-CEs are more efficient than currently available, high viscosity CEs. When RCL-MHEC was modified with Calcium-lignin sulfonate (superplasticizer), the resulting cement-based material was also better plastified than the cementitious material containing the modified MHEC 75000 product as the control. Moreover, the RCL-MHEC containing samples showed less crack formation.

It was also apparent that the addition of superplasticizer resulted in improved plastification properties.

Pure as well as modified RCL-CEs were efficient auxiliaries for cement extrusion process as compared to the control samples of currently commercially used high viscosity CEs; RCL-CEs also achieved similar application performance at reduced dosage.

Although the invention has been described with reference to preferred embodiments, it is to be understood that variations and modifications in form and detail thereof may be made without departing from the spirit and scope of the claimed invention. Such variations and modifications are to be considered within the purview and scope of the claims appended hereto.

1. A mixture composition for use in cement extrusion mortars comprising
a) a cellulose either in an amount of 20 to 99.9 wt % selected from the group consisting of alkylhydroxyalkyl celluloses, hydroxyalkyl celluloses, and mixtures thereof, prepared from raw cotton linters, and
b) at least one additive in an amount of 0.1 to 80 wt % selected form the group consisting of organic or inorganic thickening agents, anti-sag agents, air entraining agents, wetting agents, defoamers, superplasticizers, superabsorbers, dispersants, calcium-complexing agents, retarders, accelerators, water repellants, redispersible powders, biopolymers, and fibres,
wherein the mixture composition, when used in a dry cement extrusion mortar formulation and mixed with a sufficient amount of water, the formulation will produce a mortar, that can be used as mortar for extrusion of pipes, bricks, plates, distance holders or other objects, wherein the amount of the mixture composition in the mortar composition is significantly reduced, with comparable or lower crack formation while plastification and/or extrusion properties of the resulting wet mortar are improved or comparable as compared to when using conventional similar cellulose ethers.

2. The mixture composition of claim 1 wherein the alkyl group of the alkylhydroxyalkyl cellulose has 1 to 24 carbon atoms, and the hydroxyalkyl group has 2 to 4 carbon atoms.

3. The mixture composition of claim 1 wherein the cellulose ether is selected from the group consisting of methylhydroxyethylcelluloses (MHEC), methylhydroxypropylcelluloses (MHPC), hydroxyethylcellulose (HEC), ethylhyd roxyethylcelluloses (EHEC), methylethylhyd roxyethylcelluloses (MEHEC), hydrophobically modified ethylhydroxyethylcelluloses (HMEHEC), hydrophobically modified hydroxyethylcelluloses (HMHEC) and mixtures thereof.

4. The mixture composition of claim 1, wherein the mixture also comprises one or more conventional cellulose ethers selected from the group consisting of methylcellulose (MC), methylhydroxyethylcellulose (MHEC), methylhydroxypropylcellulose (MHPC), hydroxyethylcellulose (HEC), ethylhydroxyethylcellulose (EHEC), hydrophobically modified hydroxyethylcellulose (HMHEC), hydrophobically modified ethylhydroxyethylcellulose (HMEHEC), methylethylhydroxyethylcellulose (MEHEC), sulfoethyl methylhydroxyethylcelluloses (SEMHEC), sulfoethyl methylhydroxypropylcelluloses (SEMHPC), and sulfoethyl hydroxyethylcelluloses (SEHEC).

5. The mixture composition of claim 1, wherein the amount of the cellulose ether is 70 to 99.5 wt %.

6. The mixture composition of claim 1, wherein the amount of the at least one additive is 0.5 to 30 wt %

7. The mixture composition of claim 1, wherein the at least one additive is and organic thickening agent selected from the group consisting of polysaccharides.

8. The mixture composition of claim 7, wherein the polysaccharides are selected from the group consisting of starch ether, starch, guar, guar derivatives, dextran, chitin, chitosan, xylan, xanthan gum, welan gum, gellan gum, mannan, galactan, glucan, arabinoxylan, alginate, and cellulose fibres.

9. The mixture composition of claim 1, wherein the at least one additive is selected from the group consisting of homo- or co- polymers of acrylamide, gelatin, polyethylene glycol, casein, lignin sulfonates, naphthalene-sulfonate, sulfonated melamine-formaldehyde condensate, sulfonated naphthalene-formaldehyde condensate, polyacrylates, polycarboxylate ether, polystyrene sulphonates, phosphates, phosphonates, cross-linked homo- or co-polymers of acrylic acid and salts thereof, calcium-salts of organic acids having 1 to 4 carbon atoms, salts of alkanoates, aluminum sulfate, metallic aluminum, bentonite, montmorillonite, sepiolite, polyamide fibres, polypropylene fibres, polyvinyl alcohol, and homo-, co-, or terpolymers based on vinyl acetate, maleic ester, ethylene, styrene, butadiene, vinyl versatate, and acrylic monomers.

10. The mixture composition of claim 1, wherein the at least one additive is selected from the group consisting of calcium chelating agents, fruit acids, and surface active agents.

11. The mixture composition of claim 1, wherein the significantly reduced amount of the mixture used in the mortar is at least 5% reduction.

12. The mixture composition of claim 1, wherein the significantly reduced amount of the mixture used in the mortar is at least 10% reduction.

13. The mixture composition of claim 4, wherein the mixture composition is MHEC or MHPC and superplasticizer.

14. The mixture composition of claim 13, wherein the superplasticizer is selected from the group consisting of casein, lignin sulfonates, naphthalene-sulfonate, sulfonated melamine-formaldehyde condensate, sulfonated naphthalene-formaldehyde condensate, polyacrylates, polycarboxylate ether, polystyrene sulphonates, and mixtures thereof.

15. A cement extrusion mortar composition comprising hydraulic cement, fine aggregate material, and a water-retaining agent and plastification and/or extrusion auxiliary of at least one cellulose ether prepared from raw cotton linters,
wherein the dry cement extrusion mortar composition, when mixed with a sufficient amount of water, produces a wet cement extrusion mortar, that can be used for extrusion of pipes, bricks, plates, distance holders or other objects, wherein the amount of the cellulose ether in the mortar is significantly reduced with comparable or lower crack formation while plastification and/or extrusion properties of the resulting wet mortar are improved or comparable as compared to when using conventional similar cellulose ethers.

16. The cement extrusion mortar composition of claim 15, wherein the at least one cellulose ether is selected from the group consisting of alkylhydroxyalkyl celluloses and hydroxyalkyl celluloses and mixtures thereof, prepared from raw cotton linters.

17. The cement extrusion mortar composition of claim 16, wherein the alkyl group of the alkylhydroxyalkyl celluloses has 1 to 24 carbon atoms and the hydroxyalkyl group has 2 to 4 carbon atoms.

18. The cement extrusion mortar composition of claim 15, wherein the cellulose ether is selected from the group consisting of methylhydroxyethylcelluloses(MHEC), methylhydroxypropylcelluloses(MHPC), methylethylhydroxyethylcelluloses(MEHEC), ethylhydroxyethylcelluloses(EHEC), hydrophobically modified ethylhydroxyethylcelluloses(HMEHEC), hydroxyethylcelluloses(HEC), hydrophobically modified hydroxyethylcelluloses(HMHEC), and mixtures thereof.

19. The cement extrusion mortar composition of claim 18, wherein the cellulose ether, where applicable, has a methyl or ethyl degree of substitution of 0.5 to 2.5, hydroxyethyl or hydroxypropyl molar substitution (MS) of 0.01 to 6, and molar substitution (MS) of the hydrophobic substituent/substituents of 0.01-0.5 per anhydroglucose unit.

20. The cement extrusion mortar composition of claim 15, wherein the amount of cellulose ether is between 0.05 and 2.0 wt %.

21. The cement extrusion mortar composition of claim 15 in combination with one or more additives selected from the group consisting of organic or inorganic thickening agents, anti-sag agents, air entraining agents, wetting agents, defoamers, superplasticizers, superabsorber, dispersants, calcium-complexing agents, retarders, accelerators, water repellants, redispersible powders, biopolymers, and fibres.

22. The cement extrusion mortar composition of claim 21, wherein the one or more additives are organic thickening agents selected from the group consisting of polysaccharides.

23. The cement extrusion mortar composition of claim 22, wherein the polysaccharides are selected from the group consisting of starch ether, starch, guar, guar derivatives, dextran, chitin, chitosan, xylan, xanthan gum, welan gum, gellan gum, mannan, galactan, glucan, arabinoxylan, alginate, and cellulose fibres.

24. The cement extrusion mortar composition of claim 21, wherein the one or more additives are selected from the group consisting of polyacrylamide, gelatin, polyethylene glycol, casein, lignin sulfonates, naphthalene-sulfonate, sulfonated melamine-formaldehyde condensate, sulfonated naphthalene-formaldehyde condensate, polyacrylates, polycarboxylateether, polystyrene sulphonates, fruit acids, phosphates, phosphonates, cross-linked homo- or co-polymers of acrylic acid and salts thereof, calcium-salts of organic acids having 1 to 4 carbon atoms, salts of alkanoates, aluminum sulfate, metallic aluminum, bentonite, montmorillonite, sepiolite, polyamide fibres, polypropylene fibres, polyvinyl alcohol, and homo-, co-, or terpolymers based on vinyl acetate, maleic ester, ethylene, styrene, butadiene, vinyl versatate, and acrylic monomers.

25. The cement extrusion mortar composition of claim 21, wherein the amount of the one or more additives is between 0.0001 and 15 wt %.

26. The cement extrusion mortar composition of claim 15, wherein the fine aggregate material is selected from the group consisting of silica sand, dolomite, limestone, lightweight aggregates, rubber crumbs, and fly ash.

27. The cement extrusion mortar composition of claim 26, wherein the lightweight aggregates are selected from the group consisting of perlite, expanded polystyrene, cork, expanded vermiculite, and hollow glass spheres.

28. The cement extrusiori mortar composition of claim 26, wherein the fine aggregate material is present in the amount of 10-90 wt %.

29. The cement extrusion mortar composition of claim 26, wherein the fine aggregate material is present in the amount of 20-80 wt %.

30. The cement extrusion mortar composition of claim 15, wherein the hydraulic cement is selected from the group consisting of Portland cement, Portland-slag cement, Portland-silica fume cement, Portland-pozzolana cement, Portland-burnt shale cement, Portland-limestone cement, Portland-composite cement, blastfurnace cement, pozzolana cement, composite cement and calcium aluminate cement.

31. The cement extrusion mortar composition of claim 15, wherein the hydraulic cement is present in the amount of 10-90 wt %.

32. The cement extrusion mortar composition of claim 15, wherein the hydraulic cement is present in the amount of 15-70 wt %.

33. The cement extrusion mortar composition of claim 15 in combination with at least one other mineral binder selected from the group consisting of hydrated lime, gypsum, puzzolana, blast furnace slag, and hydraulic lime.

34. The cement extrusion mortar composition of claim 33, wherein the at least one mineral binder is present in the amount of 0.1-30 wt %.

35. The cement extrusion mortar composition of claim 15, wherein the significantly reduced amount of the cellulose ether used in the cement extrusion mortar composition is at least 5% reduction.

36. The cement extrusion mortar composition of claim 15, wherein the significantly reduced amount of the cellulose ether used in cement extrusion mortar composition is at least 10% reduction.

37. The cement extrusion mortar composition of claims 18, wherein the MHEC or MHPC has an aqueous Brookfield solution viscosity of greater than. 80,000 mPas as measured on a Brookfield RVT viscometer at 2 wt %, 20° C., and 20 rpm using spindle number 7.

38. The cement extrusion mortar composition of claim 18, wherein the MHEC or MHPC has an aqueous Brookfield solution viscosity of greater than 90,000 mPas as measured on a Brookfield RVT viscometer at 2 wt %, 20° C. and 20 rpm using spindle number 7.
